(19) United States
(12) Patent Application Publication
(10) Pub. No.: US 2023/0150387 A1
(43) Pub. Date: May 18, 2023

(54) POWER SYSTEM, VEHICLE, AND INFORMATION PROCESSOR

(71) Applicant: TOYOTA JIDOSHA KABUSHIKI KAISHA, Toyota-shi (JP)

(72) Inventor: Tohru NAKAMURA, Toyota-shi (JP)

(73) Assignee: TOYOTA JIDOSHA KABUSHIKI KAISHA, Toyota-shi (JP)

(21) Appl. No.: 18/052,242

(22) Filed: Nov. 3, 2022

(30) Foreign Application Priority Data
Nov. 15, 2021 (JP) 2021-185511

(51) Int. Cl. B60L 53/62; B60L 58/13; B60L 53/64; B60L 50/60; B60L 55/00; G01C 21/34

(52) U.S. Cl. CPC B60L 53/62; B60L 58/13; B60L 53/64; B60L 50/60; B60L 55/00; G01C 21/3407; B60L 2260/54; B60L 2250/10

(57) ABSTRACT

An input device receives an input operation from a user of a vehicle on which a power storage device is mounted. A notification device notifies the user of information. A setting unit sets a usable range of a state of charge of the power storage device, in accordance with a user operation performed on the input device. A charging and discharging control unit controls charging and discharging of an electric power for the power storage device, based on the usable range set by the setting unit. The setting unit calculates an expected range of the usable range, and outputs the expected range to the notification device. Using the expected range, the notification device performs a process of guiding the user so that the usable range is within the expected range.

This nonprovisional application is based on Japanese Patent Application No. 2021-185511 filed on Nov. 15, 2021 with the Japan Patent Office, the entire content of which is hereby incorporated by reference.

### BACKGROUND

### Field

The present disclosure relates to a power system, a vehicle, and an information processor.

### Description of the Background Art

Japanese Patent Laying-Open No. 2019-97334 discloses a user using a setting device to separately set a charging power set value and a discharging power set value for a vehicle which includes a power storage device capable of being charged with and discharge an electric power from power equipment provided external to the vehicle.

### SUMMARY

According to Japanese Patent Laying-Open No. 2019-97334, the user can adjust electric power charged to and discharged from the power storage device. On the other hand, however, with a power system which controls charging and discharging of a power storage device in accordance with the user settings, there can be a desire to demands charge with and discharge an electric power appropriately from the power storage device, from variety of perspectives such as inhibition of deterioration of the power storage device, the electricity cost charged to the user when the power equipment charges the vehicle, and CO2 emitted during generation of electric power to be supplied from the power equipment to the vehicle.

The present disclosure is made to solve such a problem, and an object of the present disclosure is to provide a power system, a vehicle, and an information processor that can combine a charging and discharging control desired by a user and the desire of the power system.

A power system according to a certain aspect of the present disclosure includes:

a vehicle on which a power storage device is mounted; charge and discharge equipment capable of conveying an electric power between the vehicle and outside of the vehicle;
an input device that receives an input operation from a user of the vehicle; a
notification device that notifies the user of information; a setting unit that sets a usable range of a state of charge (SOC) of the power storage device, in accordance with a user operation performed on the input device; and a charging and discharging control unit that controls charging and discharging of an electric power for the power storage device, based on the usable range set by the setting unit. The setting unit calculates an expected range of the usable range, and outputs the expected range to the notification device. Using the expected range, the notification device performs a process of guiding the user so that the usable range is within the expected range.

According to the above configuration, in the situation where the user of the vehicle sets the SOC usable range, the notification device performs the process of guiding the user so that the usable range is within the expected range desired by the power system. According to this, the user can be encouraged to set the usable range so that the usable range is within the expected range, thereby combining the charging and discharging control desired by the user and the desire of the power system.

Preferably, in the power system, the input device receives a user operation for setting at least one of an upper limit SOC indicating an upper limit of use of the SOC and a lower limit SOC indicating a lower limit of use of the SOC. The setting unit calculates and outputs to the notification device at least one of an upper limit expected value indicating an expected value of the upper limit SOC and a lower limit expected value indicating an expected value of the lower limit SOC. The notification device notifies the user of the at least one of the upper limit expected value and the lower limit expected value.

According to this, the SOC usable range is set in accordance with the user's intent, while the SOC expected range being presented to the user, thereby combining the charging and discharging control desired by the user and the desire of the power system.

Preferably, in the power system, the input device receives a user input for setting at least one of an upper limit SOC indicating an upper limit of use of the SOC and a lower limit SOC indicating a lower limit of use of the SOC. The setting unit calculates and outputs to the notification device at least one of an upper limit expected value indicating an expected value of the upper limit SOC and a lower limit expected value indicating an expected value of the lower limit SOC. When the usable range set based on the user input is out of the expected range, the notification device gives a notification to the user, encouraging the user to change the usable range.

According to this, the SOC usable range is set in accordance with the user's intent, while the user being notified of the changes in the setting based on the SOC expected range, thereby combining the charging and discharging control desired by the user and the desire of the power system.

Preferably, in the power system, the setting unit predicts a scope of use of the SOC based on a usage schedule of the vehicle or a usage history of the vehicle, and calculates the expected range in accordance with the scope of use of the SOC.

According to this, after the completion of the most-recent external charging until the performance of the next external charging, the vehicle can travel using the electric power stored in the power storage device to an extent that causes no over-discharge from the power storage device. Accordingly, the deterioration of the power storage device due to being overcharged can be inhibited from developing, while preventing a situation where the vehicle is disabled.

Preferably, in the power system, the setting unit calculates the expected range, in accordance with an electricity cost during a time period in which the power storage device is charged by the charge and discharge equipment.

According to this, when the external charging is performed during a time period in which the electricity rate is expensive, the power usage for the external charging can be reduced by lowering the upper limit expected value of the expected range, resulting in reduction of the electricity cost charged to the user. When the external charging is performed during a time period in which the electricity rate is inexpensive, more power can be stored in the power storage device by raising the upper limit expected value, without increasing the electricity cost charged to the user.

Preferably, the power system further includes power generating equipment capable of supplying the charge and discharge equipment with an electric power generated using renewable energy. The setting unit calculates the expected range, in accordance with an amount of power generated by the power generating equipment during a time period in which the power storage device is charged by the charge and discharge equipment.

According to this, when the external charging is performed during a time period in which power generation by renewable energy increases, if a surplus power is generated at the house, the external charging can use the surplus power, without dumping it, by raising the upper limit expected value of the expected range. When the demand for electric power from the house increases, the electric power stored in the vehicle can be transmitted back to the house through the charge and discharge equipment. Accordingly, CO2 emitted during generation of electric power to be supplied by a power grid, can be reduced.

Preferably, in the power system, the charge and discharge equipment conveys an electric power between the vehicle and a power grid. When the vehicle approves a request to participate in adjustment of supply and demand of the power grid, the setting unit calculates the expected range so that the expected range is greater than when participating in the adjustment is not approved by the vehicle.

According to this, if the vehicle has a schedule to participate in a request to increase the electric power demand, the upper limit expected value of the expected range is set to a higher value, thereby increasing the amount of electric power charged by the external charging, contributing to an increase of the electric power demand. If the vehicle has a schedule to participate in a request to mitigate the power shortfall, the lower limit expected value of the expected range is set to a lower value, thereby increasing an amount of electric power supplied by the external power supply, contributing to mitigation of the power shortfall by increasing the backfeeding. The contribution of the vehicle to the adjustment of the supply and demand of the power grid can be enhanced by setting the SOC usable range, taking into account as such a request to participate in adjustment of the supply and demand of the power grid. As a result, the user of the vehicle can receive a large incentive from the administrator of the power grid.

Preferably, in the power system, the input device and the notification device include a terminal device of the user. The power system further includes a communication device. The communication device communicates with the setting unit and the terminal device. The communication device transmits to the terminal device the expected range calculated by the setting unit.

According to this, when the terminal device of the user is used to set the SOC usable range, the user can be encouraged to set the usable range so that the usable range is within the expected range.

Preferably, in the power system, the communication device transmits to the setting unit the usable range received by the terminal device. The charging and discharging control unit controls charging and discharging of an electric power for the power storage device, based on the usable range received by the setting unit.

According to this, an electric power is charged to and discharged from the power storage device in accordance with the SOC usable range set by the user. Thus, the charging and discharging control desired by the user is achieved.

A vehicle according to another aspect of the present disclosure has a power storage device mounted thereon. The vehicle is capable of conveying an electric power between the vehicle and outside of the vehicle through charge and discharge equipment. The vehicle includes: an input device that receives an input operation from a user of the vehicle; a notification device that notifies the user of information; and a controller that sets a usable range of a state of charge (SOC) of the power storage device, in accordance with a user operation performed on the input device, and controls charging and discharging of an electric power for the power storage device, based on the usable range. The controller calculates an expected range of the usable range, and outputs the expected range to the notification device. Using the expected range, the notification device performs a process of guiding the user so that the usable range is within the expected range.

According to the above configuration, in a situation where the user of the vehicle sets the SOC usable range, the notification device mounted on the vehicle performs the process of guiding the user so that the usable range is within the expected range desired by the power system. According to this, the charging and discharging control desired by the user and the desire of the power system can be combined.

An information processor according to another aspect of the present disclosure manages the power system. The power system comprises: a vehicle on which a power storage device is mounted; charge and discharge equipment capable of conveying an electric power between the vehicle and outside of the vehicle; an input device that receives an input operation from a user of the vehicle; and a notification device that notifies the user of information. The information processor includes: a communication device that communicates with the input device and the notification device; and a setting unit that sets a usable range of a state of charge (SOC) of the power storage device, in accordance with a user operation performed on the input device. The setting unit calculates an expected range of the usable range. The communication device transmits to the notification device the expected range calculated by the setting unit.

According to the above configuration, the information processor (e.g., the server), which manages the power system, performs the process of guiding the user via the notification device so that the SOC usable range is within the expected range desired by the power system. According to this, the user can be encouraged to set the usable range so that the usable range is within the expected range, thereby combining the charging and discharging control desired by the user and the desire of the power system.

The information processor according to another aspect of the present disclosure communicates with the vehicle. The vehicle has a power storage device mounted whereon, and capable of conveying an electric power between the vehicle and outside of the vehicle through charge and discharge equipment. The information processor includes: an input device that receives an input operation from a user of the vehicle; a notification device that notifies the user of information; and a setting unit that sets a usable range of a state of charge (SOC) of the power storage device, in accordance with a user operation performed on the input device. The setting unit calculates an expected range of the usable range, and outputs the expected range to the notification device. Using the expected range, the notification device performs a process of guiding the user to set the usable range so that the usable range is within the expected range.

According to the above configuration, the information processor (e.g., the user terminal), which communicates with the vehicle, performs the process of guiding the user so that the SOC usable range is within the expected range desired by the power system. According to this, the charging and discharging control desired by the user and the desire of the power system can be combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing a configuration example of a vehicle to which a power system according to an embodiment according to the present disclosure is applied.

FIG. 2 is a diagram showing a schematic configuration of the power system according to the embodiment.

FIG. 3 is a diagram showing a specific configuration of an electronic control unit (ECU) included in the vehicle and a server.

FIG. 4 is a diagram showing a first example of a configuration screen for a state of charge (SOC) usable range.

FIG. 5 is a diagram showing a second example of the configuration screen of the SOC usable range.

FIG. 6 is a diagram showing a third example of the configuration screen of the SOC usable range.

FIG. 7 is a flowchart of a first example of the procedure of an SOC-usable-range setting process that is performed at the power system.

FIG. 8 is a flowchart of a second example of the procedure of the SOC-usable-range setting process that is performed at the power system.

FIG. 9 is a diagram schematically showing one example relationship between an electricity rate and an upper limit expected value.

FIG. 10 is a diagram schematically showing one example relationship between an amount of power generated by solar power generating equipment and the upper limit expected value.

FIG. 11 is a diagram showing a specific configuration of an ECU included in a vehicle and a server, according to another embodiment of the present disclosure.

FIG. 12 is a diagram showing a specific configuration of a user terminal according to another embodiment of the present disclosure.

### DESCRIPTION OF THE PREFERRED EMBODIMENTS

Hereinafter, embodiments according to the present disclosure will be described in detail, with reference to the accompanying drawings. Note that the same reference sign is used to refer to the same or like parts, and the description thereof will not be repeated.

<Configuration of Vehicle>

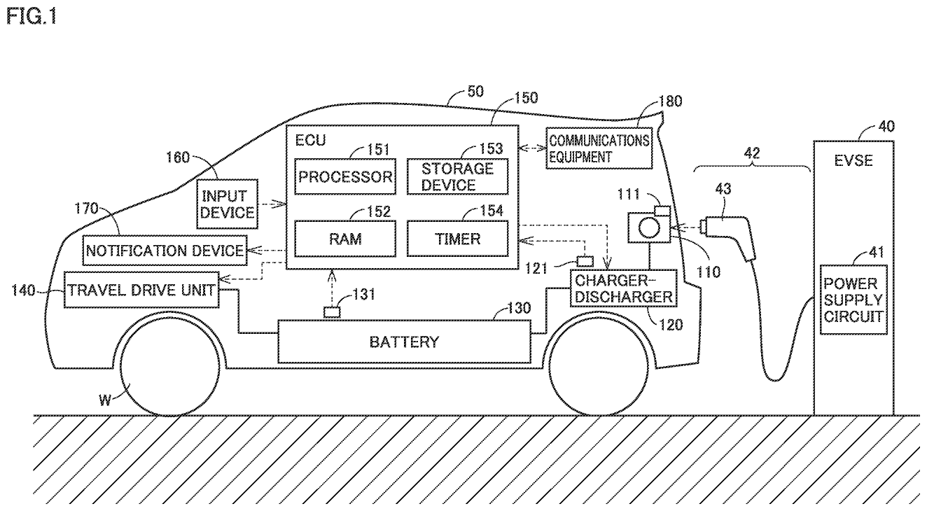

FIG. 1 is a diagram showing a configuration example of a vehicle applied to a power system according to an embodiment of the present disclosure.

As shown in FIG. 1, a vehicle 50 includes a battery 130 storing electric power for traveling. The battery 130 includes a secondary battery, for example, a lithium-ion battery or a nickel-hydrogen battery. Note that other power storage device, such as an electric double layer capacitor, may be employed, instead of the secondary battery. The battery 130 corresponds to one example of a “power storage device” according to the present disclosure.

The vehicle 50 includes an electronic control unit (hereinafter, referred to as an “ECU”) 150. The ECU 150 performs a charging control and a discharging control over the battery 130. The ECU 150 also controls communications with devices external to the vehicle 50.

The vehicle 50 may be a battery electric vehicle (BEV) capable of traveling using only the electric power stored in the battery 130, or a plug-in hybrid electric vehicle (PHEV) capable of travelling using both the electric power stored in the battery 130 and output power of an engine (not shown). The vehicle 50 may also be a vehicle that is operated by a user or capable of autonomous driving. The ECU 130 corresponds to one example of a “controller” according to the present disclosure.

The vehicle 50 further includes a monitoring module 131 that monitors conditions of the battery 130. The monitoring module 131 includes various sensors for detecting conditions (e.g., voltage, current, and temperature) of the battery 130, and outputs results of the detections to the ECU 150. The monitoring module 131 may be a battery management system (BMS) that has, in addition to the sensor functions above, a state of charge (SOC) estimation function, a state of health (SOH) estimation function, a cell voltage equalization function, a diagnosis function, and a communications function. Based on the outputs of the monitoring module 131, the ECU 150 can obtain the conditions (e.g., voltage, current, temperature, SOC, and internal resistance) of the battery 130.

The EVSE 40 is electric vehicle supply equipment. The vehicle 50 includes an inlet 110 and a charger-discharger 120, which support the power supply scheme of the EVSE 40. The inlet 110 receives an electric power supplied external to the vehicle 50. The inlet 110 also outputs an electric power supplied from the charger-discharger 120 to outside the vehicle 50. The battery 130 is capable of receiving an electric power supplied from the inlet 110 and outputting an electric power to the inlet 110. Note that the vehicle 50 may include an inlet for each power supply scheme so as to support multiple kinds of power supply schemes (e.g., an alternating-current power supply scheme and a direct-current power supply scheme).

The EVSE 40 includes a power supply circuit 41. The EVSE 40 is connected to a charging cable 42. The charging cable 42 may be connected to the EVSE 40 at all times or detachable from the EVSE 40. The charging cable 42 has a connector 43 at a tip thereof, and includes a power line therein.

The inlet 110 is connectable to the connector 43 of the charging cable 42. The inlet 110 includes a connector locking device 111. The connector locking device 111 switches the connector 43 between a locked state and an unlocked state. As the connector 43 of the charging cable 42 coupled to the EVSE 40 is connected to the inlet 110 of the vehicle 50, the EVSE 40 and the vehicle 50 are electrically connected together. This allows an electric power to be supplied from the EVSE 40 to the vehicle 50 through the charging cable 42.

The charger-discharger 120 is disposed between the inlet 110 and the battery 130. The charger-discharger 120 includes a relay which switches a power path from the inlet 110 to the battery 130 between on and off, and a power converter circuit (e.g., a bidirectional converter), none of which are shown. The relay and the power converter circuit are each controlled by the ECU 150.

The vehicle 50 further includes a monitoring module 121 that monitors conditions of the charger-discharger 120. The monitoring module 121 includes various sensors that detects conditions (e.g., voltage, current, and temperature) of the charger-discharger 120, and outputs results of the detections to the ECU 150. In the example of FIG. 1, the monitoring module 121 detects voltage and current input to the power converter circuit, and voltage and current output from the power converter circuit.

Connecting the EVSE 40 and the inlet 110 together via the charging cable 42 enables an electric power to be conveyed between the EVSE 40 and the vehicle 50. This enables external charging by the vehicle 50 (i.e., charging of the battery 130 of the vehicle 50 with supply of an electric power from outside the vehicle 50). The electric power for the external charging is supplied from, for example, the EVSE 40 to the inlet 110 through the charging cable 42. The charger-discharger 120 converts the electric power received by the inlet 110 into one that is appropriate for charging the battery 130 with, and outputs to the battery 130 the electric power obtained by the conversion.

Connecting the EVSE 40 and the inlet 110 together via the charging cable 42 also enables external power supply by the vehicle 50 (i.e., supply of an electric power from the vehicle 50 to the EVSE 40 through the charging cable 42). The electric power for the external power supply is supplied from the battery 130 to the charger-discharger 120. The charger-discharger 120 converts the electric power supplied from the battery 130 into one that is appropriate for external power supply, and outputs to the inlet 110 the electric power obtained by the conversion.

When either the external charging or the external power supply is performed, the relay of the charger-discharger 120 is in a closed state (a connected state). When none of the external charging or the external power supply is performed, the relay of the charger-discharger 120 is in an open state (a disconnected state). Note that the configuration of the charger-discharger 120 is not limited to the above, and may be modified, as appropriate.

The ECU 150 includes a processor 151, a random access memory (RAM) 152, a storage device 153, and a timer 154. For example, a central processing unit (CPU) is employed as the processor 151. The RAM 152 functions as a working memory temporality storing data processed by the processor 151.

The storage device 153 is capable of saving the stored information. The storage device 153 includes, for example, a read only memory (ROM) and a rewritable nonvolatile memory. Besides programs, the storage device 153 stores information (e.g., maps, mathematical formulas, and various parameters) which are used in the programs. In the present embodiment, the processor 151 executes the programs stored in the storage device 153, thereby the ECU 150 performing various controls. However, the various controls performed by the ECU 150 are not limited to be performed by software, and can be performed by dedicated hardware (electronic circuit). Note that the ECU 150 may include any number of processors, and a processor may be prepared for each predetermined control.

The timer 154 notifies the processor 151 of the arrival of a set time. Upon arrival of the time set to the timer 154, the timer 154 transmits a signal for notifying the processor 151 of this. In the present embodiment, a timer circuit is employed as the timer 154. However, the timer 154 may be implemented by software, rather than by hardware (the timer circuit). The ECU 150 can also obtain the current time by using a real-time clock (RTC) circuit (not shown) built in the ECU 150.

The vehicle 50 further includes a travel drive unit 140, an input device 160, a notification device 170, a communications equipment 180, and driving wheels W. Note that the drive system of the vehicle 50 is not limited to the front-wheel drive illustrated in FIG. 1, and may be a rear-wheel drive or a four-wheel drive.

The travel drive unit 140 includes a power control unit (PCU) and a motor generator (MG), none of which are shown. The travel drive unit 140 causes the vehicle 50 to travel using the electric power stored in the battery 130. For example, the PCU includes: a controller, which includes a processor; an inverter; a converter; and a relay (hereinafter, referred to as a “system main relay (SMR)”). The controller of the PCU receives instructions (control signals) from the ECU 150, and controls the inverter, the converter, and the SMR of the PCU, in accordance with the instructions. The MG is, for example, a three-phase alternating-current (AC) motor generator, and driven by the PCU and thereby rotates the driving wheels W. The MG also regenerates an electric power, and supplies the electric power to the battery 130. The SMR switches a power path from the battery 130 to the PCU between on and off. The SMR is in a closed state (the connected state) while the vehicle 50 is traveling.

The input device 160 receives user operations. The input device 160 is operated by the user, and outputs signals corresponding to user operations to the ECU 150. The input device 60 may have a wired or wireless scheme. The input device 160 is, for example, various switches, various pointing devices, a keyboard, and a touch panel. The input device 160 may be an operating unit included in a car navigation system. The input device 160 may be a smart speaker which receives speech input. The input device 160 corresponds to one example of an “input device” according to the present disclosure.

The notification device 170 performs a predetermined inform process to the user (e.g., a passenger of the vehicle 50), in response to a request from the ECU 150. The notification device 170 may include at least one of a display device (e.g., a touch panel display), a loudspeaker, and a lamp. The notification device 170 may be a meter panel, a head up display, or a car navigation system. The notification device 170 corresponds to one example of a “notification device” according to the present disclosure. Note that the input device 160 and the notification device 170 form an “interface” for interacting with the user. The input device 160 and the notification device 170 may be separate components or a one component.

The communications equipment 180 includes various communication interfaces (I/F). The communications equipment 180 may include a data communication module (DCM). The communications equipment 180 may include a 5G (the fifth-generation mobile communications system)-enabled communication I/F. The ECU 150 wirelessly communicates with communication devices external to the vehicle 50, through the communications equipment 180.

<Configuration of Power System>

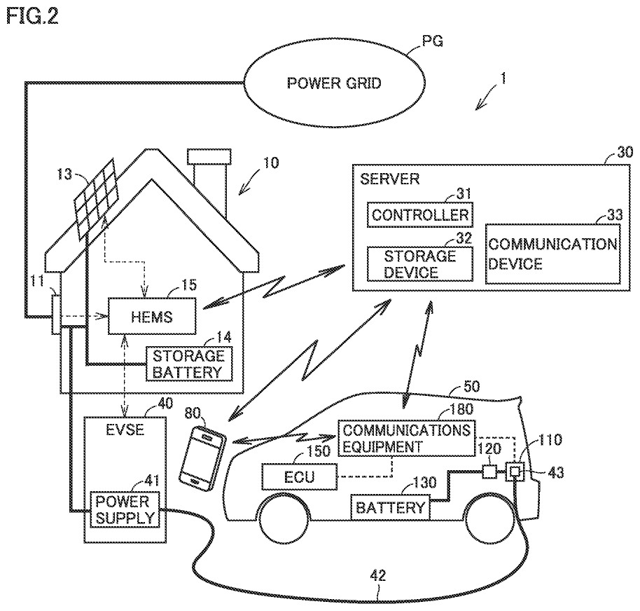

FIG. 2 is a diagram showing a schematic configuration of the power system according to the present embodiment.

As shown in FIG. 2, a power system 1 according to the present embodiment includes a power grid PG, a home energy management system (HEMS) 15, a switchboard 11, solar power generating equipment 13, a storage battery 14, a server 30, the EVSE 40, the vehicle 50, and a user terminal 80. The vehicle 50 has the configuration as illustrated in FIG. 1. The HEMS 15, the solar power generating equipment 13, and the storage battery 14 are provided in a house 10 (e.g., a user's house) where the EVSE 40 is installed.

The user terminal 80 corresponds to one example of a “terminal device” carried by the user of the vehicle 50. In the example of FIG. 2, smartphone which includes a touch panel display is employed as the user terminal 80. However, the present disclosure is not limited thereto. Any terminal device can be employed as the user terminal 80.

The vehicle 50 is electrically connected to the EVSE 40 via the charging cable 42, while being parked in a parking area of the house 10 where the EVSE 40 is installed. The EVSE 40 is AC power supply equipment that supports backfeeding. The power supply circuit 41 converts an electric power supplied from the power grid PG into one that is appropriate for external charging, and also converts an electric power supplied from the vehicle 50 into one that is appropriate for backfeeding. However, the power system 1 may include power supply equipment that does not support backfeeding or include DC power supply equipment (e.g., a fast charger).

As the connector 43 of the charging cable 42 coupled to the EVSE 40 is connected to the inlet 110 of the vehicle 50, communications are enabled between the vehicle 50 and the EVSE 40, and an electric power can also be conveyed between the vehicle 50 and the EVSE 40. The vehicle 50 electrically connected to the EVSE 40 is electrically connected to the power grid PG via the EVSE 40. This completes preparation for external charging and external power supply.

The communications equipment 180 mounted on the vehicle 50 communicates with the EVSE 40 via the charging cable 42. The communication scheme between the EVSE 40 and the vehicle 50 may be any, for example, a controller area network (CAN) or a power line communication (PLC). The communications equipment 180 also wirelessly communicates with the server 30 via a mobile communication network (telematics), for example. The signals exchanged between the communications equipment 180 and the server 30 may be encrypted.

Furthermore, in the present embodiment, the communications equipment 180 mounted on the vehicle 50 and the user terminal 80 wirelessly communicate with each other. The ECU 150 can control the user terminal 80 through wireless communications to cause the user terminal 80 to give notifications to the user. The communications between the communications equipment 180 and the user terminal 80 may be a short-range communication (e.g., a direct communication in the vehicle and in an area around the vehicle) such as Bluetooth (registered trademark).

A predetermined application software (hereinafter, simply referred to as an “app”) is installed in the user terminal 80. The user terminal 80 can be carried by the user of the vehicle 50, and exchange information with the HEMS 15 and the server 30 through the app. The user can operate the app through, for example, the touch panel display of the user terminal 80. The touch panel display of the user terminal 80 can also give notifications to the user of the vehicle 50. The user terminal 80 (the touch panel display) corresponds to one example of an “interface” according to the present disclosure for interaction with the user. The server 30 contacts the user of the vehicle 50 through a predetermined contact (e.g., the user terminal 80 or the communications equipment 180).

The HEMS 15 manages the supply and demand of an electric power that is used in the house 10. The HEMS 15 wirelessly communicates with the user terminal 80 and the server 30 via the communication network. The HEMS 15 is electrically connected to the EVSE 40 and a consumer electronics (not shown) that runs on power supplied from the power grid PG. The HEMS 15 is also electrically connected to the solar power generating equipment (the solar panel) 13 and the storage battery 14.

The solar power generating equipment 13 generates an electric power using the renewable energy, and the power output from the solar power generating equipment 13 varies depending on a meteorological condition. The storage battery 14 is a rechargeable power storage element, and, a secondary battery, typically, a lithium-ion battery, a nickel-hydrogen battery, or a lead storage battery, etc. is applied. Besides the electric power from the vehicle 50, the storage battery 14 can be supplied with the electric power generated by the solar power generating equipment 13 and the electric power from the power grid PG.

Note that if a surplus power is generated at the house 10 (e.g., a surplus amount of electric power generated by the solar power generating equipment 13), the surplus power can be stored in the vehicle 50 through the EVSE 40. Thereafter, in the event of an increase of the electric power demand from the house 10, the electric power stored in the vehicle 50 can be transmitted back to the house 10 through the EVSE 40.

The HEMS 15 measures the amount of electric power supplied from the EVSE 40 to the vehicle 50. The HEMS 15 also measures the amount of electric power that is back fed from the vehicle 50 to the EVSE 40. The HEMS 15 stores a measured power usage and transmits it to the server 30. The HEMS 15 also measures the amount of electric power generated by the solar power generating equipment 13. The HEMS 15 stores the measured amount of generated power, and transmits it to the server 30. The HEMS 15 may periodically transmit the measured power usage and the measured amount of generated power to the server 30, or transmit them to the server 30 upon request.

The server 30 is capable of communications with the vehicle 50, the HEMS 15, and the user terminal 80. The server 30 belongs to the administrator of the power grid PG, and corresponds to a management computer for the power grid PG. The server 30 corresponds to one example of an “information processor” according to the present disclosure.

The server 30 includes a controller 31, a storage device 32, and a communication device 33. The controller 31 includes a processor, performs predetermined information processing and controls the communication device 33. The storage device 32 is capable of saving various information. Besides the programs executed by the controller 31, the storage device 32 stores information (e.g., maps, mathematical formulas, and various parameters) which are used in the programs. The communication device 33 includes various communication I/Fs. The controller 31 communicates externally through the communication device 33.

<SOC Usable Range of Battery 130>

As noted above, in the power system 1, the external charging and the external power supply by the vehicle 50 are enabled by the connector 43 of the charging cable 42 coupled to the EVSE 40 being connected to the inlet 110 of the vehicle 50. Accordingly, the travel distance of the vehicle 50 can be ensured by fully charging the battery 130 by the external charging. In addition, a power demand peak can be mitigated by supplying the house 10 (or the power grid PG) with the electric power that is stored in the battery 130 by the external power supply during a time period that has a peak electric power demand from the house 10 (or the power grid PG).

In the present embodiment, the user can set an SOC usable range of the battery 130. The “SOC usable range,” as used herein, is defined by an “upper limit SOC” indicating the upper limit of use of the SOC and a “lower limit SOC” indicating the lower limit of use of the SOC. The user can set at least one of the upper limit SOC and the lower limit SOC, using an input device that receives user operations. Note that the user terminal 80 or the input device 160 mounted on the vehicle 50 can be used as the input device.

Meanwhile, the deterioration of the battery 130, represented by a secondary battery, is promoted by the battery 130 being kept in the over-charged state or the over-discharged state. Therefore, if the user sets the upper limit SOC to a high SOC regime, the battery 130 is kept in the over-charged state after the completion of the external charging until the next travel, which may promote the deterioration of the battery 130. If the user sets the lower limit SOC to a low SOC regime, the battery 130 is kept in the over-discharged state after the vehicle 50 travels or after the end of the external power supply, which may promote the deterioration of the battery 130. Accordingly, it is required that the SOC usable range be set in accordance with the usage of the vehicle 50 so that the battery 130 can be prevented from being kept in the over-charged state or the over-discharged state.

When the user performs the external charging using the electric power supplied from the power grid PG, the user has to pay the electricity cost for the charge amount (an amount of electric power used for the charging) to the power company. The electricity charge unit price (an electricity cost per unit amount of electric power) varies, depending on a time period. Thus, if the time period in which external charging is performed has a higher electricity charge unit price, an increased electricity cost may be charged to the user. In order to reduce the electricity cost charged to the user, preferably, the SOC usable range (the upper limit SOC) is set so that the charge amount is reduced during a time period that has a high electricity charge unit price.

When the external charging is performed in a time period in which a surplus amount power is generated from the electric power generated by the solar power generating equipment 13, the above-described electricity cost charged to the user can be reduced by using the surplus power to perform the external charging. The CO2 emitted during generation of electric power to be supplied by the power grid PG, can also be reduced. From the perspective of reduction of CO2 emission, preferably, the SOC usable range (the upper limit SOC) is set in response to the presence or absence of the generation of surplus power so that a large amount of surplus power can be stored in the battery 130.

Furthermore, in the power system 1, the supply-demand balance of electric power may be adjusted, using a demand response (hereinafter, referred to as a “DR”). The DR is an approach for adjusting the demand for electric power by requesting, by a DR signal, a respective customer to reduce or increase the electric power demand. Note that the DR signal includes a DR signal requesting for reduction of the electric power demand (hereinafter, also referred to as a “negawatt-DR signal”), and a DR signal requesting for increase of the electric power demand (hereinafter, also referred to as a “posiwatt-DR signal”).

When the user of the vehicle 50 receives a DR signal, the user can charge or discharge an electric power from the vehicle 50 in accordance with a DR by using the EVSE 40, thereby contributing to adjusting the demand for power. As a result, the user of the vehicle 50 can receive a predetermined incentive from the administrator of the power grid. In order for the user of the vehicle 50 to respond to the request to participate in the DR and receive an incentive, desirably, the SOC usable range is expanded.

As such, an SOC usable range that is good to achieve any one of the inhibition of the deterioration of the battery 130, reduction of the electricity cost charged to the user, CO2 emission reduction, and power leveling may be determined, and the vehicle 50 may be demanded to meet this SOC usable range.

Thus, in the present embodiment, from the perspective stated above, the power system 1 calculates a good SOC usable range as an “expected range,” and outputs the expected range to the notification device for notifying the user of information. Then, in a situation where the user of the vehicle 50 uses the input device to set the SOC usable range, the notification device performs a process of guiding the user so that the SOC usable range is within the expected range.

<Configuration of ECU 150 and Server 30>

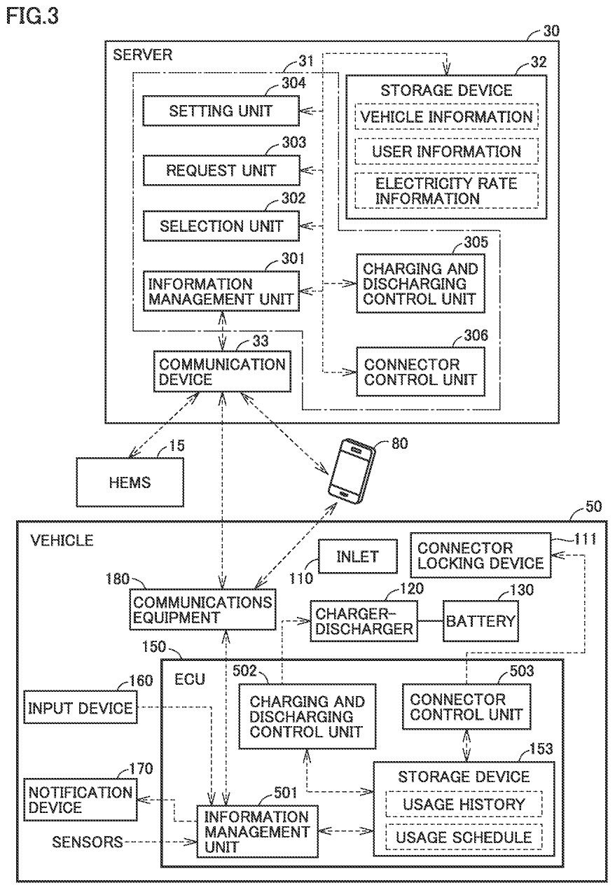

FIG. 3 is a diagram showing a specific configuration of the ECU 150 and the server 30.

As shown in FIG. 3, the ECU 150 includes an information management unit 501, a charging and discharging control unit 502, and a connector control unit 503. These components are embodied by the processor 151 of FIG. 1 executing programs stored in the storage device 153. However, the present disclosure is not limited thereto. These components may be embodied by dedicated hardware components (electronic circuits).

Based on given information, the information management unit 501 updates the information in the storage device 153. The output signal of the input device 160, the results of detections by the various sensors mounted on the vehicle 50, and the information received by the communications equipment 180 from outside the vehicle 50 are input to the information management unit 501.

The storage device 153 stores information related to a usage history of the vehicle 50. The usage history of the vehicle 50 includes travel histories such as previous travel routes and travel time of the vehicle 50. The usage history of the vehicle 50 also includes execution history of previous external chargings and external power supplies.

The storage device 153 also stores information related to a usage schedule of the vehicle 50. The usage schedule of the vehicle 50 includes a travel schedule, a charging schedule, and a DR schedule of the vehicle 50. The travel schedule is information that indicates the travel start time, the travel end time, and the travel route that are scheduled by the user. The user can register the travel schedule with the storage device 153 through the input device 160. The charging schedule is information indicating the charge schedule scheduled by the user. The user can register the charging schedule with the storage device 153 through the input device 160. The DR schedule is information indicating a DR duration set to the vehicle 50.

The information management unit 501 transmits the usage history and the usage schedule of the vehicle 50 to the server 30. The information management unit 501 also obtains conditions of the vehicle 50 (e.g., a charging cable connection state, a connector locked/unlocked state, and the SOC of the battery 130), and transmits the obtained information to the server 30. The charging cable connection state is information indicating whether the connector 43 of the charging cable 42 is connected to the inlet 110. The connector locked/unlocked state is information indicating whether the connector 43 connected to the inlet 110 is in the locked state or the unlocked state. These information are transmitted to the server 30, together with the vehicle ID. The transmission timing can be set arbitrarily. For example, the information management unit 501 may transmit predetermined information to the server 30 at predetermined cycles. Alternatively, the information management unit 501 may transmit the data stored in the storage device 153 to the server 30 at a predetermined time (e.g., at the end of travel of the vehicle 50 or upon connection with the connector 43).

If the user of the vehicle 50 is requested by the server 30 to participate in the DR, the information management unit 501 responds to the server 30 as to whether the user of the vehicle 50 approves the request. Specifically, if the communications equipment 180 receives the request, the information management unit 501 controls the notification device 170, thereby encouraging the user of the vehicle 50 to reply to the request. Then, as the user enters in the input device 160 the information indicating whether the user approves the request, the information management unit 501 replies to the server 30 with a result of the user's decision. Note that in the above embodiment in which the request is transmitted to the user terminal 80, the user terminal 80 may have a function of making the response.

The charging and discharging control unit 502 controls the charger-discharger 120, thereby performing the charging and discharging control over the battery 130, based on the SOC usable range of the battery 130. If the vehicle 50 is ready for external charging and conditions for starting the external charging are met, the charging and discharging control unit 502 starts the external charging. If the vehicle 50 is ready for external power supply and conditions for starting the external power supply are met, the charging and discharging control unit 502 starts the external power supply. The conditions for starting the external charging and the external power supply may each be met when the user performs a predetermined start operation or upon arrival of a start time set by the user.

While the charging and discharging control over the battery 130 is, basically, performed according to programs implemented in the ECU 150, it should be noted that during the DR duration, the charging and discharging control unit 502 is remotely controlled by the server 30. Due to this, during the DR duration, the server 30 performs the charging and discharging control over the battery 130. Note that the charging and discharging control unit 502 may be able to switch the remotely control between permitted and not permitted. The user may also be able to switch the remotely control between permitted and not permitted, through the input device 160. The remote control by the server 30 over the charging and discharging control unit 502 may be permitted if the user of the vehicle 50 approves the request from the server 30 to participate in the DR.

The connector control unit 503 controls the connector locking device 111, thereby performing a connector control (i.e., a lock/unlock control over the connector 43 connected to the inlet 110). Upon a request for the connector control (a connector lock request/a connector unlock request), the connector control unit 503 performs the connector control in accordance with the request. In the present embodiment, at least one of the input device 160 and the user terminal 80 receives a request for the connector control from the user. As the user enters a request for the connector control in the input device 160 or the user terminal 80, the connector control unit 503 performs the connector control in accordance with the request input by the user. If the communications equipment 180 receives a request for the connector control from the server 30, the connector control unit 503 performs the connector control, in accordance with the request received from the server 30.

The controller 31 of the server 30 includes an information management unit 301, a selection unit 302, a request unit 303, a setting unit 304, a charging and discharging control unit 305, and a connector control unit 306. The components of the server 30 are embodied by the processor of the controller 31 of FIG. 3 and programs executed by the processor (e.g., programs stored in the storage device 32). However, the present disclosure is not limited thereto. These components may be embodied by dedicated hardware components (electronic circuits).

The information management unit 301 manages information of each registered user (hereinafter, also referred to as “user information”), and information of each registered vehicle 50 (hereinafter, also referred to as “vehicle information”). The user information and the vehicle information are stored in the storage device 32.

Identification information identifying a user (hereinafter, also referred to as a “user ID”) is given for each user. The information management unit 301 distinctly manages the user information by user ID. The user ID also functions as information identifying the user terminal 80 (a terminal ID). The user information contains a communication address of the user terminal 80 and the vehicle ID of the vehicle 50 belonging to the user. The user information also contains information indicating an amount of power generated by the solar power generating equipment 13 installed in the user's house 10, which is received from the HEMS 15.

The vehicle ID is identification information identifying the vehicle 50. A vehicle ID is given for each vehicle 50. The information management unit 301 distinctly manages the vehicle information by vehicle ID. The vehicle information contains a communication address of the communications equipment 180 mounted on the vehicle 50, and the vehicle information (e.g., the usage history, the usage schedule, the charging cable connection state, and the connector locked/unlocked state of the vehicle 50, the SOC of the battery 130, and the power usage at the EVSE 40), which is received from a respective vehicle 50.

Upon receiving electricity rate information from a higher-level server (not shown), the information management unit 301 saves the electricity rate information to the storage device 32. The “electricity rate information” is information in which an electric power supply area, an electric power supply time, and an electricity rate are associated with each other. Upon receiving a DR request signal from the higher-level server, the information management unit 301 saves the DR request signal to the storage device 32.

Based on the DR request signal, the selection unit 302 selects a DR vehicle. The selection unit 302 may select a DR vehicle, taking into account the charging cable connection state, the SOC of the battery 130, and the usage schedule of the vehicle 50.

Based on the DR request signal, the request unit 303 creates a charge and discharge command for each DR vehicle. The request unit 303 may create a charge and discharge command for the DR vehicle, taking into account the conditions of each DR vehicle. The information management unit 301 transmits the charge and discharge command created by the request unit 303 to each DR vehicle selected by the selection unit 302. The process as described above allows a charge and discharge command to be transmitted to each DR vehicle from the server 30 during a DR duration indicated by the DR request signal.

Based on the SOC usable range of the battery 130, the charging and discharging control unit 305 performs the charging and discharging control over the battery 130 mounted on the DR vehicle. The connector control unit 306 performs the connector control over the DR vehicle.

The setting unit 304 sets the SOC usable range for the battery 130, in accordance with a user operation performed on the input device. The SOC usable range of the battery 130 is defined by the upper limit SOC and the lower limit SOC, as noted above. In the present embodiment, at least one of the input device 160 and the user terminal 80 can function as the input device that receives the SOC usable range input operation by the user of the vehicle 50. Thus, the user is allowed to operate the input device 160 or the user terminal 80 to set at least one of the upper limit SOC and the lower limit SOC.

The setting unit 304 uses at least one of the vehicle information, the user information, and the electricity rate information, which are stored in the storage device 32, to calculate the expected range of the SOC usable range (hereinafter, also referred to as an “SOC expected range”). The SOC expected range corresponds to a good SOC usable range that is demanded for the vehicle 50 to achieve any of the inhibition of deterioration of the battery 130, reduction of the electricity cost charged to the user, CO2 emission reduction, and power leveling.

The SOC expected range is defined by an “upper limit expected value” indicating an expected value of the upper limit SOC and a “lower limit expected value” indicating an expected value of the lower limit SOC. The setting unit 304 calculates at least one of the upper limit expected value and the lower limit expected value, using a method described below. The setting unit 304 transmits the calculated SOC expected range to the notification device.

Using the SOC expected range received from the setting unit 304, the notification device performs a process of guiding the user so that the SOC usable range is within the SOC expected range. Specifically, if the user terminal 80 is the input device that has received a setting request, the user terminal 80, upon receiving the SOC expected range from the server 30, controls the touch panel display, thereby performing the process of guiding the user so that the SOC usable range is within the SOC expected range. If the input device 160 is the input device that has received the setting request, the information management unit 501, upon receiving the SOC expected range via the communications equipment 180, controls the notification device 170, thereby performing the process of guiding the user so that the SOC usable range is within the SOC expected range. Then, as the user finalizes the settings of the SOC usable range, the notification device transmits the finalized SOC usable range to the server 30.

At the server 30, the information management unit 301 stores the SOC usable range received from the notification device into the storage device 32. The setting unit 304 sets the SOC usable range, in accordance with the SOC usable range finalized by the user.

<Settings of SOC Usable Range of Battery 130>

Next, settings of the SOC usable range of the battery 130 is described. In the following, the user operates the user terminal 80 and sets the SOC usable range. In other words, the user terminal 80 is the “input device” and the “notification device.” Note that if the user operates the input device 160 in the vehicle 50 to set the SOC usable range, the input device 160 and the notification device 170 are the “input device” and the “notification device,” respectively.

(Example Configuration Screen of SOC Usable Range)

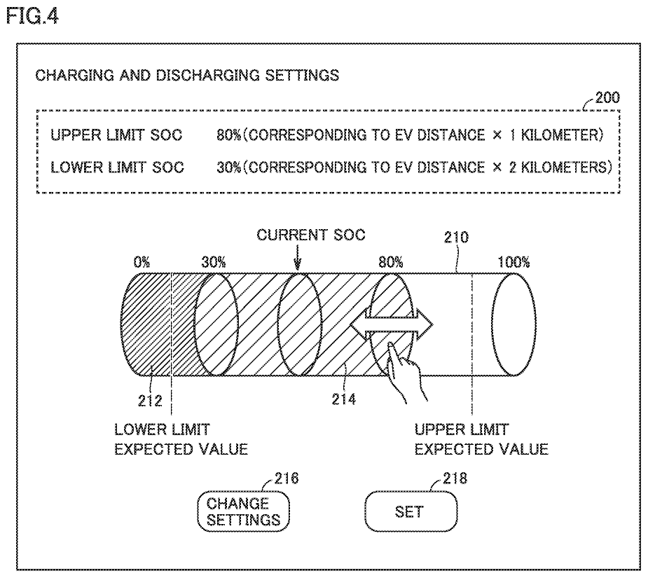

FIG. 4 is a diagram showing a first example of a configuration screen of the SOC usable range shown on the touch panel display of the user terminal 80. As shown in FIG. 4, the configuration screen includes a settings display unit 200, a settings bar 210, display bars 212, 214, and buttons 216, 218.

The settings display unit 200 shows the current set value of the upper limit SOC indicating the upper limit of the SOC usable range, and the current set value of the lower limit SOC indicating the lower limit of the SOC usable range. Note that the EV distance (a distance that the vehicle 50 can travel with the electric power stored in the battery 130) where the SOC is at the upper limit SOC may be displayed together with the set value of the upper limit SOC, and the EV distance where the SOC is at the lower limit SOC may be displayed together with the set value of the lower limit SOC, as illustrated in the figure. Such an EV distance can be calculated from: the power storage calculated from the SOC; and the power consumption efficiency of the vehicle 50.

The display bar 212 is displayed on the settings bar 210, showing the current set value of the lower limit SOC by bar length. The display bar 214 is also displayed on the settings bar 210, showing the current set value of the upper limit SOC by bar length. Furthermore, the current SOC is displayed on the settings bar 210.

The user can set the upper limit SOC by performing an operation of touching the right end of the display bar 214 displayed on the settings bar 210 and sliding the display bar 214 in the left-right direction (corresponding to the direction of the arrow in the figure). The user can also set the lower limit SOC by performing an operation of touching and sliding the right end of the display bar 212 displayed on the settings bar 210 in the left-right direction. The set value is displayed in numeric value on the settings display unit 200. Note that EV distances, corresponding to the set values of the upper limit SOC and the lower limit SOC, are also displayed in numeric value on the settings display unit 200.

The button 216 allows the user to change at least one of the upper limit SOC and the lower limit SOC displayed on the settings display unit 200. After performing the operation of touching the button 216, the user can change the settings of at least one of the upper limit SOC and the lower limit SOC, using the settings bar 210.

The button 218 is a button for completing the setup of the upper limit SOC and the lower limit SOC after the touch operation is performed on the button 216. The user can finalize the settings of the upper limit SOC and the lower limit SOC by performing an operation of touching the button 218.

As the button 218 is operated by the user, the user terminal 80 transmits the finalized set values of the upper limit SOC and the lower limit SOC to the server 30. At the server 30, the setting unit 304 sets an SOC usable range, in accordance with the set values of the upper limit SOC and the lower limit SOC received from the user terminal 80.

When the SOC usable range is set, the user terminal 80 performs the process of guiding the user so that the SOC usable range is within the SOC expected range. Specifically, the upper limit expected value indicating the expected value of the upper limit SOC, and the lower limit expected value indicating the expected value of the lower limit SOC are displayed on the settings bar 210. In the example of FIG. 4, the upper limit expected value and the lower limit expected value are displayed, overlaying the display bars 212 and 214, respectively. Note that the upper limit expected value and the lower limit expected value, the EV distance where the SOC is at the upper limit expected value, and the EV distance where the SOC is at the lower limit expected value may be displayed in numeric value on the settings display unit 200.

According to this, the user sets the upper limit SOC by performing an operation of touching and sliding the right end of the display bar 214, while referring to the upper limit expected value. At this time, the upper limit expected value acts as a deterrent against the operation of sliding the right end of the display bar 214 in the right direction beyond the upper limit expected value. As a result, the user can be encouraged to set the upper limit SOC not exceeding the upper limit expected value.

Similarly, the user sets the lower limit SOC by performing the operation of touching and sliding the right end of the display bar 212 while referring to the lower limit expected value. At this time, the lower limit expected value acts as a deterrent against the operation of sliding the right end of the display bar in the left direction beyond the lower limit expected value. As a result, the user can be encouraged to set the lower limit SOC not falling behind the lower limit expected value.

The SOC expected range set by the server 30 is presented as such to the user on the user terminal 80, thereby guiding the user to set the SOC usable range within the SOC expected range. However, since the settings of the SOC usable range is left up to the user operation, the user can set the upper limit SOC higher than the upper limit expected value and the lower limit SOC lower than the lower limit expected value.

As described above, according to the first example, the SOC usable range is set in accordance with the user's intent, while presenting the SOC expected range to the user, thereby combining the charging and discharging control desired by the user and the desire of the power system 1.

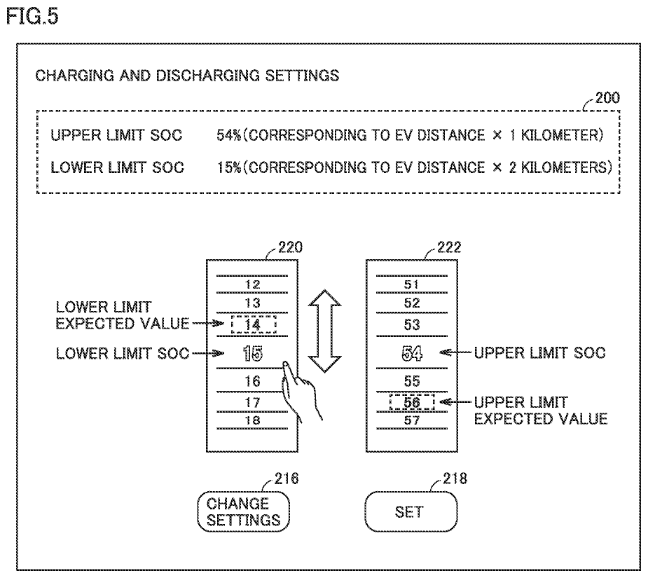

FIG. 5 is a diagram showing a second example of the configuration screen of the SOC usable range. As shown in FIG. 5, the configuration screen includes a settings display unit 200, settings bars 220, 222, and buttons 216, 218. The configuration screen of FIG. 5 is the same as the configuration screen of FIG. 4, except for including the settings bars 220, 222, in place of the settings bar 210 and the display bars 212, 214.

The settings bar 220 shows the current set value of the lower limit SOC in numeric value. The user can set the lower limit SOC by performing an operation of touching and sliding the numeric value in the vertical direction (corresponding to the direction of the arrow in the figure).

The settings bar 222 shows the current set value of the upper limit SOC in numeric value. The user can set the upper limit SOC by performing an operation of touching and sliding the numeric value in the vertical direction.

In the example of FIG. 5, the lower limit expected value is displayed in numeric value on the settings bar 220. Accordingly, similarly to the first example of FIG. 4, the user can be encourage to set the lower limit SOC not falling behind the lower limit expected value. In addition, the upper limit expected value is displayed in numeric value on the settings bar 222. Accordingly, the user can be encouraged to set the upper limit SOC not exceeding the upper limit expected value. As such, even in the second example, the SOC usable range is set in accordance with the user's intent, while presenting the SOC expected range to the user, thereby combining the charging and discharging control desired by the user and the desire of the power system 1.

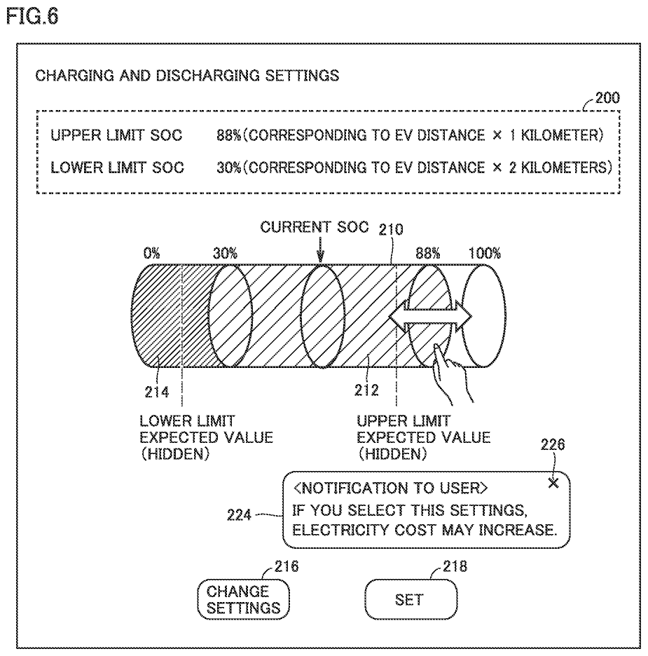

FIG. 6 is a diagram showing a third example of the configuration screen of the SOC usable range. As shown in FIG. 6, the configuration screen includes a settings display unit 200, a settings bar 210, display bars 212, 214, and buttons 216, 218.

The basic configuration of the configuration screen of FIG. 6 is the same as the configuration screen of FIG. 4. However, the configuration screen of FIG. 6 differs from the configuration screen of FIG. 4 in that the upper limit expected value and the lower limit expected value on the settings bar 210 are hidden on the configuration screen of FIG. 6.

Since the upper limit expected value is not presented to the user in the example of FIG. 6, the user can perform an operation of touching and sliding the right end of the display bar 212 in any manner to set the upper limit SOC. However, if the upper limit SOC set by the user is beyond the upper limit expected value, the user terminal 80 gives a notification to the user, encouraging to change the settings of the upper limit SOC.

Specifically, as shown in FIG. 6, the user terminal 80 displays on the configuration screen a message object 224 encouraging the user to change the settings of the upper limit SOC. For example, if the upper limit expected value is set, taking into account the electricity cost charged to the user, the message object 224 is displayed, showing “If you select this settings, the electricity cost may increase.” The content of the message object 224 is appropriately set, in accordance with an intent of the SOC expected range the vehicle 50 is demanded to have.

The configuration screen further shows a delete button 226 which accepts deletion of the message object 224. The user can delete the message object 224 from the configuration screen by touching the delete button 226. Once the message object 224 is deleted, the user can set the upper limit SOC again, by performing the operation of touching and sliding the right end of the display bar 212. In other words, the user terminal 80 just gives a notification to the user, encouraging to change the settings of the upper limit SOC, and the settings of the upper limit SOC is left up to a user operation. Accordingly, the user can set the upper limit SOC higher than the upper limit expected value.

Although not shown in the figure, the user terminal 80 displays the message object 224 encouraging the user to change the settings of the lower limit SOC even if the lower limit SOC set by the user is less than the lower limit expected value. For example, if the lower limit expected value is set, taking into account the inhibition of deterioration of the battery 130, the message object 224 is displayed, showing “If you select this settings, the battery 130 may be deteriorated.”

By touching the delete button 226 and deleting the message object 224 from the configuration screen, the user can perform the operation of touching and sliding the right end of the display bar 214 to set the lower limit SOC again. The user terminal 80 just gives a notification to the user, encouraging to change the setting of the lower limit SOC, and settings of the lower limit SOC is left up to a user operation. Accordingly, the user can set the lower limit SOC lower than the lower limit expected value.

As such, if the SOC usable range is out of the SOC expected range set by the server 30, the user terminal 80 gives a notification to the user, encouraging to change the settings, thereby guiding the user to set the SOC usable range within the SOC expected range. However, since the settings of the SOC usable range is left up to the user operation, the user can set the upper limit SOC higher than the upper limit expected value and the lower limit SOC lower than the lower limit expected value.

As described above, according to the third example, the SOC usable range is set in accordance with the user's intent, while giving the user a notification encouraging the user to change the settings based on the SOC expected range, thereby combining the charging and discharging control desired by the user and the desire of the power system 1.

(Flowchart)

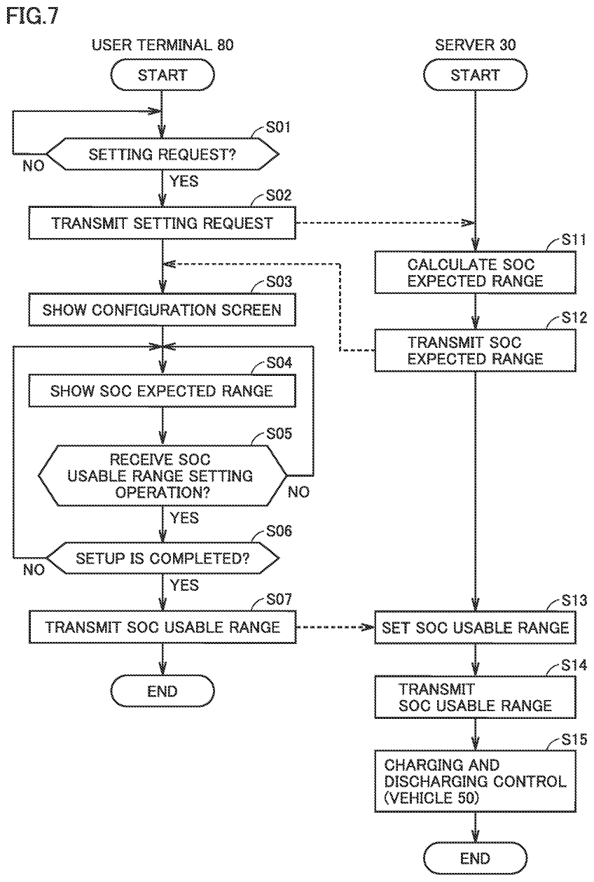

FIG. 7 is a flowchart of a first example of the procedure of an SOC-usable-range setting process that is performed at the power system 1. The flowchart shows the procedure of a setting process corresponding to the example configuration screens described with respect to FIGS. 4 and 5. The set of process steps illustrated in the flowchart are performed by the user terminal 80 and the server 30 if the user uses the user terminal 80 to set the SOC usable range.

In the figure, the process performed by the user terminal 80 is illustrated on the left, and the process performed by the server 30 is illustrated on the right. Each process step is implemented by software processing by the processor included in the user terminal 80 and software processing by the controller 31 of the server 30. However, respective process steps may be implemented by hardware components such as LSIs (Large Scale Integration) which are disposed in the user terminal 80 and the server 30.

In step (hereinafter, simply denoted as “S”) 01, the user terminal 80 determines whether the user terminal 80 receives an SOC-usable-range setting request from the user of the vehicle 50. S01 is YES if, for example, the user launches an app preinstalled in the user terminal 80, otherwise, it is NO.

If received an SOC-usable-range setting request (YES in S01), the user terminal 80, in S02, transmits the setting request to the server 30.

Upon receiving the setting request from the user terminal 80, the server 30, in S11, calculates an SOC expected range, using at least one of the vehicle information, the user information, and the electricity rate information that are stored in the storage device 32. In S11, the server 30 calculates at least one of the upper limit expected value and the lower limit expected value. In S12, the server 30 transmits the SOC expected range to the user terminal 80.

In S03, the user terminal 80 shows the configuration screen of the SOC usable range on the touch panel display. In S04, the user terminal 80 shows the SOC expected range received from the server 30 on the configuration screen, together with the current upper limit SOC and the current lower limit SOC (see FIGS. 4 and 5). At least one of the upper limit expected value and the lower limit expected value is displayed on the configuration screen.

In S05, the user terminal 80 determines whether the user terminal 80 receives an SOC usable range setting operation on the configuration screen. S05 is YES if an operation of touching the button 216 and an operation of touching and sliding the right end of at least one of the display bars 212, 214 are performed on the configuration screen of FIG. 4. S05 is YES if an operation of touching the button 216 and an operation of touching and sliding the numeric value of at least one of the settings bars 220, 222 are performed on the configuration screen of FIG. 5.

In S06, the user terminal 80 determines whether the user has completed the setup of the SOC usable range. S06 is YES if an operation of touching the button 218 is performed on the configuration screens of FIGS. 4 and 5. The process steps of S04 through S06 are repeatedly performed until S06 is YES.

If the user completes the setup of the SOC usable range (YES in S06), the user terminal 80, in S07, transmits to the server 30 the SOC usable range set by the user. Upon receiving the user setting value of the SOC usable range from the user terminal 80, the server 30, in S13, sets an SOC usable range in accordance with the user setting value.

In S14, the server 30 transmits the SOC usable range to the vehicle 50. In S15, the server 30 and the vehicle 50 perform the charging and discharging control over the battery 130, based on the SOC usable range of the battery 130.

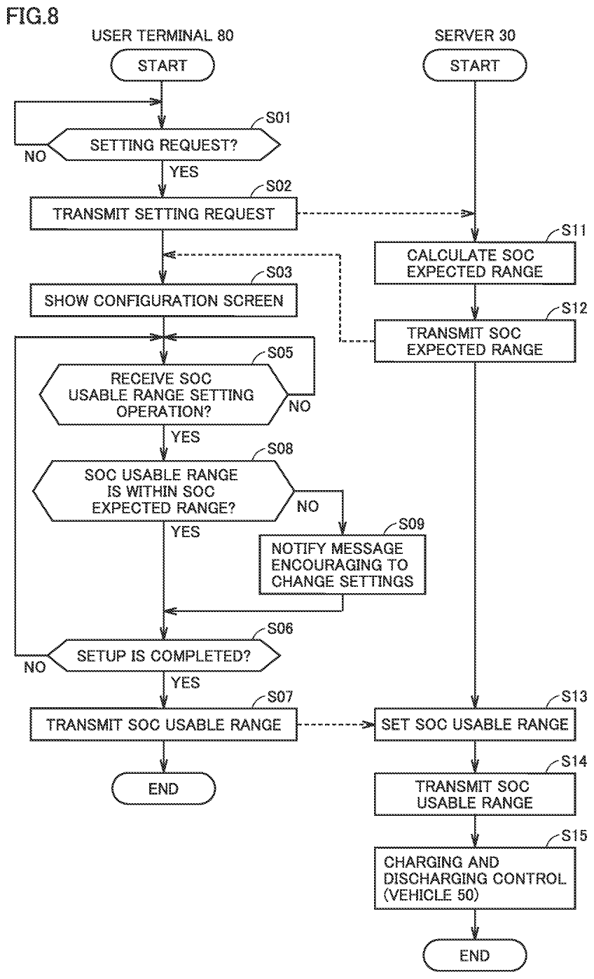

FIG. 8 is a flowchart of a second example of the procedure of the SOC-usable-range setting process that is performed at the power system 1. The flowchart shows the procedure of a setting process corresponding to the example configuration screen described with respect to FIG. 6. The set of process steps illustrated in the flowchart are performed by the user terminal 80 and the server 30 if the user uses the user terminal 80 to set the SOC usable range.

In the figure, the process performed by the user terminal 80 is illustrated on the left, and the process performed by the server 30 is illustrated on the right. The flowchart shown in FIG. 8 is the same as the flowchart of FIG. 7, except for not including S04 and adding S08 and S09 to the process performed by the user terminal 80.

In FIG. 8, the user terminal 80 does not display the SOC expected range received from the server 30 on the configuration screen. If the user terminal 80 determines that the SOC usable range setting operation performed on the configuration screen is received in S05 (YES in S05), the user, in S08, determines whether the SOC usable range is within the SOC expected range. S08 is YES if the upper limit SOC is less than or equal to the upper limit expected value and the lower limit SOC is greater than or equal to the lower limit expected value, otherwise, it is NO.

If determined that the SOC usable range is out of the SOC expected range (NO in S08), the user terminal 80, in S09, notifies the user of a message encouraging the user to change the settings of the SOC usable range. For example, as shown in FIG. 6, the user terminal 80 displays on the configuration screen the message object 224 encouraging the user to change the settings of the SOC usable range. Note that the user having received the message object 224 can resume the SOC usable range setting operation by touching the delete button 226 displayed on the configuration screen and thereby deleting the message object 224.

<Calculation of SOC Expected Range>

Next, calculation of the SOC expected range of the battery 130 is described. In the following, the server 30 (the setting unit 304) calculates the SOC expected range.

As noted above, the SOC expected range of the battery 130 is an SOC usable range of the battery 130 that the power system 1 requests from the vehicle 50. The SOC expected range can be calculated from the perspectives of, for example, (1) inhibition of deterioration of the battery 130, (2) reduction of the electricity cost charged to the user, (3) CO2 emission reduction, and (4) response to a request to participate in the DR. In the following, methods of calculation of the SOC expected range based on the respective perspectives are described.

(1) Inhibition of Deterioration of Battery 130

As a first mode, the setting unit 304 of the server 30 uses the vehicle information stored in the storage device 32 to predict the scope of use of the SOC of the battery 130 in the vehicle 50. The vehicle information contains the usage schedules (the travel schedule, the charging schedule) of the vehicle 50, and the usage histories (the travel history, the execution history of the external charging) of the vehicle 50.

Upon receiving an SOC-usable-range setting request from the user, the setting unit 304, using these information, predicts an amount of electric power that is required for the vehicle 50 to travel after the completion of the most-recent external charging until the next external charging. Specifically, using the travel schedule and the charging schedule, the setting unit 304 predicts an EV distance after the completion of the most-recent external charging until the next external charging. Then, from the predicted value of the EV distance and the power consumption efficiency of the vehicle 50, the setting unit 304 calculates an amount of electric power that is required for the vehicle 50 to travel. Alternatively or additionally to the travel schedule and the charging schedule, using the travel history and the external charging execution history, the setting unit 304 may predict an amount of electric power that is required for the vehicle 50 to travel.

The setting unit 304 calculates the SOC expected range based on the predicted value of the amount of electric power that is required for the vehicle 50 to travel. The lower limit expected value is set higher than a threshold of the SOC that can cause the battery 130 to over-discharge an electric power. The upper limit expected value is calculated by adding the predicted amount of electric power to the lower limit expected value.

According to this, during a period after the completion of the most-recent external charging until the performance of the next external charging, the vehicle 50 is allowed to travel, using the electric power stored in the battery 130 to an extent that does not cause over-discharging of the electric power stored in the battery 130. The shorter the EV distance to the next external charging, the lower the upper limit expected value. Setting the upper limit SOC in accordance with the upper limit expected value can inhibit the deterioration of the battery 130 from developing due to overcharge, while preventing a situation in which the vehicle 50 is disabled.

(2) Reduction of Electricity Cost Charged to User

As a second mode, the setting unit 304 of the server 30 calculates an SOC expected range, using the electricity rate information and the vehicle information stored in the storage device 32. The electricity rate information is information in which an electric power supply area, an electric power supply time period, and an electricity rate are associated with each other.

The setting unit 304 refers to the electricity rate information, and the charging schedule and the external charging execution history, which are included in the vehicle information, to calculate the electricity rate during a time period in which external charging is performed. Based on the electricity rate, the setting unit 304 calculates the upper limit expected value.

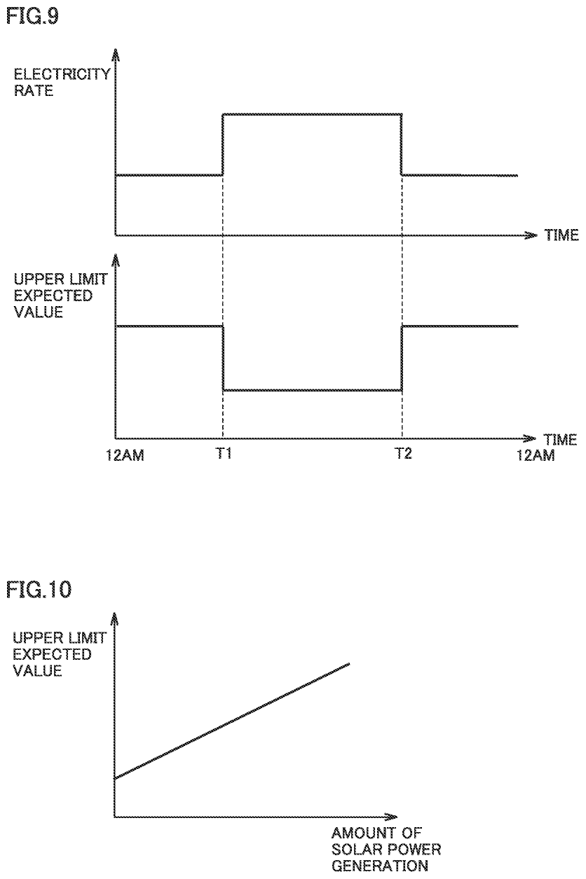

FIG. 9 is a diagram schematically showing one example relationship between the electricity rate and the upper limit expected value. The upper part of FIG. 9 shows a graph of the electricity rate over time of a day. The lower part of FIG. 9 shows a graph of the upper limit expected value over time of the day.

In the example of FIG. 9, the electricity rate for a predetermined time period (time T1 to time T2) of a day is set higher than electricity rates of the other time periods. The time period from time T1 to time T2 is, for example, the time period from 7 AM to 11 PM. According to this, the electricity rate is inexpensive during late night hours from 11 PM to 7 AM next morning, which allows reduction of the electricity cost charged to the user. Therefore, in the example of FIG. 9, the upper limit expected value for the time period from time T1 to time T2 is lower than the upper limit expected values for the other time periods.

Upon receiving an SOC-usable-range setting request from the user, the setting unit 304 uses the charging schedule and/or the external charging execution history of the vehicle 50 to predict a time period in which the next external charging is performed. The setting unit 304 refers to the relationship shown in FIG. 9 to calculate an upper limit expected value, based on the electricity rate during the time period in which the next external charging is performed.

According to this, when the external charging is performed during a time period in which the electricity rate is expensive, the upper limit expected value is low, and the power usage for the external charging can therefore be reduced, resulting in reduction of the electricity cost charged to the user. When the external charging is performed during a time period in which the electricity rate is inexpensive, the upper limit expected value is high, and more power can therefore be stored in the battery 130, without increasing the electricity cost charged to the user.

(3) Reduction of CO2 Emission

As a third mode, the setting unit 304 of the server 30 calculates an SOC expected range, using the power generation information stored in the storage device 32. The power generation information indicates an amount of power generated by the solar power generating equipment 13 installed in the user's house 10.

The setting unit 304 refers to the power generation information, and the charging schedule and the external charging execution history included in the vehicle information, to predict an amount of power that is generated by the solar power generating equipment 13 during a time period in which external charging is performed. Note that the amount of power generated by the solar power generating equipment 13 varies, depending on a meteorological condition such as the weather, a time period, and a season, etc.

Specifically, upon receiving an SOC-usable-range setting request, the setting unit 304 predicts a time period in which the next external charging is performed, using the charging schedule and/or the external charging execution history of the vehicle 50. The setting unit 304 also predicts an amount of power generated by the solar power generating equipment 13 during the time period in which external charging is performed, from the track record of the amounts of power generated by the solar power generating equipment 13, and a meteorological condition (the predicted value) during the time period in which external charging is performed, etc. Based on the predicted amount of power generated by the solar power generating equipment 13, the setting unit 304 calculates an upper limit expected value.

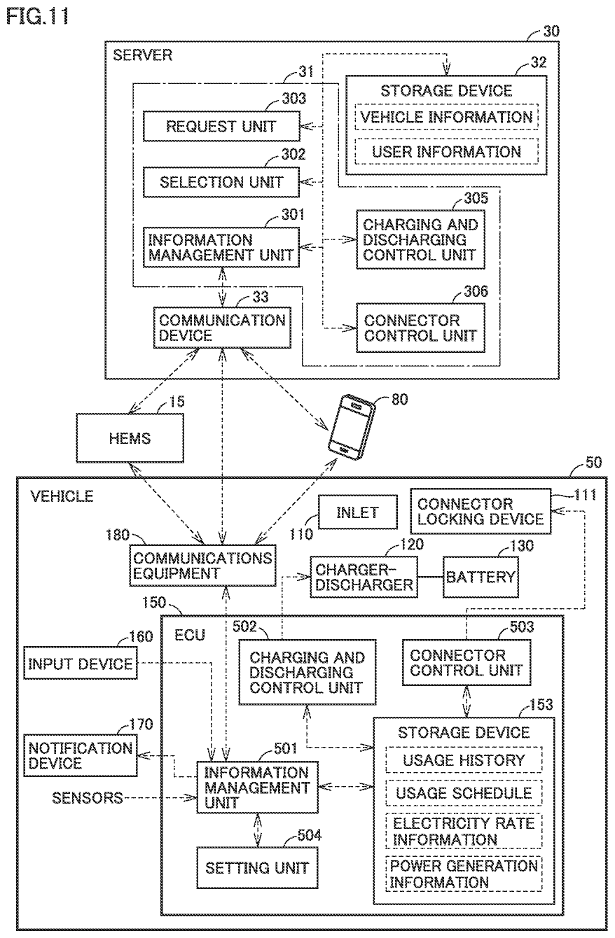

FIG. 10 is a diagram schematically showing one example relationship between the amount of power generated by the solar power generating equipment 13 and the upper limit expected value. In FIG. 10, the amount of power generated by the solar power generating equipment 13 is indicated on the horizontal axis, and the upper limit expected value is indicated on the vertical axis.

In FIG. 10, the upper limit expected value is set so as to increase with an increase of an amount of power generated by the solar power generating equipment 13. The setting unit 304 refers to the relationship shown in FIG. 10 to calculate the upper limit expected value, based on the predicted value of the amount of power that is generated by the solar power generating equipment 13 during the time period in which external charging is performed.

According to this, the upper limit expected value increases when the external charging is performed during a time period in which the solar power generating equipment 13 generates an increased amount of power generated. Therefore, if a surplus power is generated at the house 10, the surplus power can be used for the external charging, without dumping it. In addition, when the electric power demand from the house 10 increases, the electric power stored in the vehicle 50 can be transmitted back to the house 10 through the EVSE 40. Accordingly, CO2 emitted during generation of electric power to be supplied from the power grid PG can be reduced.

Note that, in the present embodiment, while the description has been given, with reference to setting the upper limit expected value in response to an amount of power generated by the solar power generating equipment 13 installed in the house 10, the upper limit expected value may be set in response to a renewable energy ratio of the electric power supplied from the power grid PG. The “renewable energy ratio” is a ratio of an electric power that is generated using a renewable energy (solar energy, wind power energy, geothermal energy, etc.) to an overall electric power generated, the renewable energy having a low environmental impact. The electric power generated using the renewable energy emits little CO2. Owing to this, the higher the renewable energy ratio, the less the CO2 emitted during generation of electric power.

In this case, the setting unit 304 obtains, through a higher-level server, the information indicating the renewable energy ratio of the electric power supplied from the power grid PG, refers to the obtained information, the charging schedule and the external charging execution history of the vehicle 50, and predicts a renewable energy ratio during a time period in which external charging is performed. The setting unit 304 sets the upper limit expected value so that the upper limit expected value increases with an increase of the predicted renewable energy ratio.

(4) Response to Request to Participate in DR

As a fourth mode, the setting unit 304 of the server 30 calculates an SOC expected range, using the DR schedule stored in the storage device 32. The DR schedule is information that indicates a DR duration set to the vehicle 50.

If the user of the vehicle 50 approves the request to participate in a DR, the setting unit 304, upon receiving an SOC-usable-range setting request from the user, refers to the DR schedule and determines whether the vehicle 50 has a schedule to participate in a DR. If the vehicle 50 has a schedule to participate in a DR, the setting unit 304 calculates an SOC expected range so that the SOC expected range is greater than the default value of a predetermined SOC usable range.

For example, if the vehicle 50 has a schedule to participate in a posiwatt DR requesting for an increase of the electric power demand, the setting unit 304 sets the upper limit expected value higher than the default value of the upper limit SOC. If the vehicle 50 has a schedule to participate in a negawatt DR requesting for mitigation of power shortfall (e.g., reduction of the electric power demand, or backfeeding), the setting unit 304 sets the lower limit expected value lower than the default value of the lower limit SOC.

According to this, the charge amount by external charging can be increased in a posiwatt DR duration, thereby contributing to an increase of the electric power demand. The amount of power supplied by external power supply can be increased in a negawatt DR duration, thereby contributing to mitigation of the power shortfall by increasing the backfeeding. The contribution of the vehicle 50 to the adjustment of the supply and demand of the power grid can be enhanced by setting the SOC usable range, taking into account as such a request to participate in a DR. As a result, the user of the vehicle 50 can receive a large incentive from the administrator of the power grid.

As described above, in the present embodiment, if the SOC expected range desired by the power system 1 is output to the interface, the interface performs a process of guiding the user of the vehicle 50 so that the SOC usable range is within the SOC expected range in the situation where the user sets the SOC usable range. Since the user can be encouraged to set the SOC usable range so that the SOC usable range is within the SOC expected range, thereby combining the charging and discharging control desired by the user and the desire of the power system 1.

### OTHER EMBODIMENTS

(1) In the embodiments described above, the server 30 sets the SOC usable range in accordance with a user operation performed on a user interface where the interface is the user terminal 80, or the input device 160 and the notification device 170 of the vehicle 50. However, the vehicle 50 may set the SOC usable range.

FIG. 11 is a diagram showing a specific configuration of an ECU 150 included in a vehicle 50, and a server 30, according to another embodiment of the present disclosure. As shown in FIG. 11, the ECU 150 of the vehicle 50 differs from the ECU 150 of FIG. 3 in that the ECU 150 includes a setting unit 504. The server 30 differs from the server 30 of FIG. 3 in that the server 30 does not have the setting unit 304.

In the configuration example of FIG. 11, the storage device 153 of the vehicle 50 includes the electricity rate information, and information indicating an amount of power generated by the solar power generating equipment 13, in addition to the information related to the usage history of the vehicle 50 and the information related to the usage schedule of the vehicle 50.

Upon receiving an SOC-usable-range setting request from a user via a user terminal 80, the setting unit 504 calculates an SOC expected range, using information stored in a storage device 153. An information management unit 501 transmits the SOC expected range to a user terminal 80 via a communications equipment 180. Note that if an input device 160 receives the setting request, the information management unit 501 outputs the SOC expected range to a notification device 170. Upon receiving the SOC usable range set by the user from the user terminal 80 or the input device 160, the setting unit 504 sets the SOC usable range in accordance with the user settings.

(2) In the embodiments described above, the server 30 sets the SOC usable range in accordance with a user operation performed on an interface where the interface is the user terminal 80. However, the user terminal 80 may set the SOC usable range.

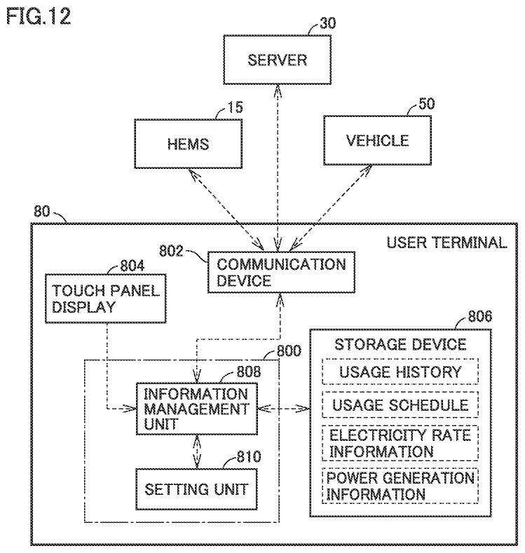

FIG. 12 is a diagram showing a specific configuration of a user terminal 80 according to another embodiment of the present disclosure. As shown in FIG. 12, the user terminal 80 includes a controller 800, a communication device 802, a touch panel display 804, and a storage device 806. The controller 800 includes a processor, and performs predetermined information processing and controls the communication device 802. The storage device 806 is capable of saving various information. Besides programs (including apps) executed by the controller 31, the storage device 806 stores information which are used in the program. The communication device 802 includes various communication I/Fs. The controller 800 communicates externally through the communication device 802.

The controller 800 includes an information management unit 808 and a setting unit 810. Upon receiving, from the vehicle 50, the information related to the usage history of the vehicle 50, the information related to the usage schedule of the vehicle 50, the electricity rate information, and the information indicated the amount of power generated by the solar power generating equipment 13, the information management unit 808 saves the received information to the storage device 806.

If the touch panel display 804 receives an SOC-usable-range setting request from the user, the setting unit 810 calculates an SOC expected range, using the information stored in the storage device 806. The information management unit 808 outputs the SOC expected range to the touch panel display 804. Using the SOC expected range, the touch panel display 804 performs a process of guiding the user so that the SOC usable range is within the SOC expected range. Upon receiving the SOC usable range set by the user from the touch panel display 804, the setting unit 810 sets an SOC usable range in accordance with the user settings. The information management unit 808 transmits the SOC usable range to the server 30 and the vehicle 50 via the communication device 802.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power system, comprising:
a vehicle on which a power storage device is mounted;
charge and discharge equipment capable of conveying an electric power between the vehicle and outside of the vehicle;
an input device that receives an input operation from a user of the vehicle;
a notification device that notifies the user of information;
a setting unit that sets a usable range of a state of charge (SOC) of the power storage device, in accordance with a user operation performed on the input device; and
a charging and discharging control unit that controls charging and discharging of an electric power for the power storage device, based on the usable range set by the setting unit, wherein
the setting unit calculates an expected range of the usable range, and outputs the expected range to the notification device, and
using the expected range, the notification device performs a process of guiding the user so that the usable range is within the expected range.

2. The power system according to claim 1, wherein
the input device receives a user operation for setting at least one of an upper limit SOC indicating an upper limit of use of the SOC and a lower limit SOC indicating a lower limit of use of the SOC,
the setting unit calculates and outputs to the notification device at least one of an upper limit expected value indicating an expected value of the upper limit SOC and a lower limit expected value indicating an expected value of the lower limit SOC, and
the notification device notifies the user of the at least one of the upper limit expected value and the lower limit expected value.

3. The power system according to claim 1, wherein
the input device receives a user input for setting at least one of an upper limit SOC indicating an upper limit of use of the SOC and a lower limit SOC indicating a lower limit of use of the SOC,
the setting unit calculates and outputs to the notification device at least one of an upper limit expected value indicating an expected value of the upper limit SOC and a lower limit expected value indicating an expected value of the lower limit SOC, and
when the usable range set based on the user input is out of the expected range, the notification device gives a notification to the user, encouraging the user to change the usable range.

4. The power system according to claim 1, wherein
the setting unit predicts a scope of use of the SOC based on a usage schedule of the vehicle or a usage history of the vehicle, and calculates the expected range in accordance with the scope of use of the SOC.

5. The power system according to claim 1, wherein
the setting unit calculates the expected range, in accordance with an electricity cost during a time period in which the power storage device is charged by the charge and discharge equipment.

6. The power system according to claim 1, further comprising
power generating equipment capable of supplying the charge and discharge equipment with an electric power generated using renewable energy, wherein
the setting unit calculates the expected range, in accordance with an amount of power generated by the power generating equipment during a time period in which the power storage device is charged by the charge and discharge equipment.

7. The power system according to claim 1, wherein
the charge and discharge equipment conveys an electric power between the vehicle and a power grid, and
when the vehicle approves a request to participate in adjustment of supply and demand of the power grid, the setting unit calculates the expected range so that the expected range is greater than when participating in the adjustment is not approved by the vehicle.

8. The power system according to claim 1, wherein
the input device and the notification device include a terminal device of the user,
the power system further comprising
a communication device that communicates with the setting unit and the terminal device, and transmits to the terminal device the expected range calculated by the setting unit.

9. The power system according to claim 8, wherein
the communication device transmits to the setting unit the usable range received by the terminal device, and
the charging and discharging control unit controls charging and discharging of an electric power for the power storage device, based on the usable range received by the setting unit.

10. A vehicle on which a power storage device is mounted, the vehicle being capable of conveying an electric power between the vehicle and outside of the vehicle through charge and discharge equipment, the vehicle comprising:
an input device that receives an input operation from a user of the vehicle;
a notification device that notifies the user of information; and
a controller that
sets a usable range of a state of charge (SOC) of the power storage device, in accordance with a user operation performed on the input device, and
controls charging and discharging of an electric power for the power storage device, based on the usable range, wherein
the controller calculates an expected range of the usable range, and outputs the expected range to the notification device, and
using the expected range, the notification device performs a process of guiding the user so that the usable range is within the expected range.

11. An information processor for managing a power system, wherein
the power system comprises:
a vehicle on which a power storage device is mounted;
charge and discharge equipment capable of conveying an electric power between the vehicle and outside of the vehicle;
an input device that receives an input operation from a user of the vehicle; and
a notification device that notifies the user of information,
the information processor includes:
a communication device that communicates with the input device and the notification device; and
a setting unit that sets a usable range of a state of charge (SOC) of the power storage device, in accordance with a user operation performed on the input device, wherein
the setting unit calculates an expected range of the usable range, and
the communication device transmits to the notification device the expected range calculated by the setting unit.
